(19) United States
(12) Patent Application Publication
(10) Pub. No.: US 2013/0069021 A1
(43) Pub. Date: Mar. 21, 2013

(54) TIN OXIDE-CONTAINING POLYMER COMPOSITE MATERIALS

(71) Applicants: Arno LANGE, Bad Duerkheim (DE); Gerhard Cox, Bad Duerkheim (DE); Klaus Leitner, Ludwigshafen (DE); Hannes Wolf, Ludwigshafen (DE); Michael Mehring, Chemnitz (DE); Christian Leonhardt, Chemnitz (DE)

(72) Inventors: Arno LANGE, Bad Duerkheim (DE); Gerhard Cox, Bad Duerkheim (DE); Klaus Leitner, Ludwigshafen (DE); Hannes Wolf, Ludwigshafen (DE); Michael Mehring, Chemnitz (DE); Christian Leonhardt, Chemnitz (DE)

(73) Assignee: BASF SE, Ludwigshafen (DE)

(21) Appl. No.: 13/613,696

(22) Filed: Sep. 13, 2012

Related U.S. Application Data
(60) Provisional application No. 61/536,085, filed on Sep. 19, 2011.

(51) Int. Cl. H01B 1/08; C07F 7/22

(52) U.S. Cl. 252/519.33; 556/81; 549/3; 556/108

(57) ABSTRACT

A tin oxide-containing polymer composite material, a process for production thereof, and use thereof for production of tin-carbon composite material containing: an inorganic tin-containing phase; and a carbon phase. Additionally, a compound of formula (I): R¹—X—Sn—Y—R² (I), wherein: R¹ is an Ar—C(R^{a},R^{b})— radical where Ar is an aromatic or heteroaromatic ring optionally containing 1 or 2 substituents; R^{a} and R^{b} are each independently hydrogen or methyl, or together are an oxygen atom or a methylidene group (═CH₂); R² is C₁-C₁₀-alkyl, C₃-C₈-cycloalkyl, or R¹; or R¹ together with R² is a radical of the formula A:

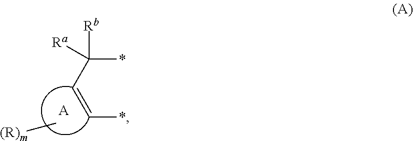

wherein: A is an aromatic or heteroaromatic ring fused to the double bond; m is 0-2; each R radical is independently selected from halogen, CN, C₁-C₆-alkyl, C₁-C₆-alkoxy, and phenyl, R^{a}, R^{b} are as in formula (1); X is O, S or NH; and Y is O, S or NH.

The present invention relates to novel tin oxide-containing polymer composite materials, to a process for production thereof and to the use thereof for production of tin-carbon composite material composed of at least one inorganic tin-containing phase in which the tin is present in elemental form or in the form of tin(II) oxide or in the form of a mixture thereof; and of a carbon phase in which carbon is present in elemental form. Such tin-carbon composite materials are particularly suitable for production of anode materials for electrochemical cells, especially lithium cells. The invention also relates to compounds (monomers) for production of the inventive tin oxide-containing polymer composite materials.

In an increasingly mobile society, mobile electrical devices are playing an ever greater role. For many years, batteries, especially rechargeable batteries (called secondary batteries or accumulators), have therefore been finding use in virtually all areas of life. There is now a complex profile of demands on secondary batteries with regard to the electrical and mechanical properties thereof. For instance, the electronics industry is demanding new, small, lightweight secondary cells or batteries with high capacity and high cycling stability to achieve a long lifetime. In addition, the thermal sensitivity and the self-discharge rate should be low in order to ensure high reliability and efficiency. At the same time, a high level of safety in the course of use is required. Lithium secondary batteries with these properties are especially also of interest for the automotive sector, and can be used, for example, in the future as energy stores in electrically operated vehicles or hybrid vehicles. In addition, there is a requirement here for batteries which have advantageous electrokinetic properties in order to be able to achieve high current densities. In the development of novel battery systems, there is also a special interest in being able to produce rechargeable batteries in an inexpensive manner. Environmental aspects are also playing a growing role in the development of new battery systems.

The cathode of a modern high-energy lithium battery now comprises, as an electroactive material, typically lithium-transition metal oxides or mixed oxides of the spinel type, for example LiCoO₂, LiNiO₂, LiNi_{1-x-y}CoₓM_{y}O₂ (0<x<1, y<1, M e.g. Al or Mn) or LiMn₂O₄, or lithium iron phosphates, for example. For the construction of the anode of a modern lithium battery, the use of lithium-graphite intercalation compounds has been proven in the last few years (Journal Electrochem. Soc. 1990, 2009). In addition, as anode materials, lithium-silicon intercalation compounds, lithium alloys and lithium titanate have been examined (see K. E. Aifantis, “Next generation anodes for secondary Li-ion batteries” in High Energy Density Li-Batteries, Wiley-VCH, 2010, p. 129-162). The two electrodes are combined with one another in a lithium battery using a liquid or else solid electrolyte. In the (re)charging of a lithium battery, the cathode material is oxidized (for example according to the following equation: LiCoO₂→n Li⁺+Li₍₁₋ₙ₎CoO₂+n e⁻). This releases the lithium from the cathode material and it migrates in the form of lithium ions to the anode, where the lithium ions are bound with reduction of the anode material, and in the case of graphite intercalated as lithium ions with reduction of the graphite. In this case, the lithium occupies the interlayer sites in the graphite structure. In the course of discharging of the battery, the lithium bound within the anode is removed from the anode in the form of lithium ions, and oxidation of the anode material takes place. The lithium ions migrate through the electrolytes to the cathode and are bound therein with reduction of the cathode material. Both in the course of discharging of the battery and in the course of recharging of the battery, the lithium ions migrate through the separator.

However, a significant disadvantage in the case of use of graphite in Li ion batteries lies in the comparatively low specific capacity with a theoretical upper limit of 0.372 Ah/g. Similar properties are also possessed by graphite-like carbon materials other than graphite, for example carbon black, such as acetylene black, lamp black, furnace black, flame black, cracking black, channel black or thermal black, and shiny carbon or hard carbon. In addition, such anode materials are not unproblematic in terms of safety.

Higher specific capacities can be achieved in the case of use of lithium alloys, for example LiₓSi, LiₓPb, LiₓSn, LiₓAl or LiₓSb alloys. These enable charge capacities up to 10 times the charge capacity of graphite (LiₓSi alloy; see R. A. Huggins, Proceedings of the Electrochemical society 87-1, 1987, p. 356-64). A significant disadvantage of such alloys is the change in their dimensions in the course of charging/discharging, which leads to disintegration of the anode material. A consequence which results from the resulting increase in the specific surface area of the anode material is losses of capacity caused by irreversible reaction of the anode material with the electrolyte, and increased sensitivity of the cell to thermal stress, which can lead in the extreme case to strongly exothermic destruction of the cell and is a safety risk.

The use of lithium as an electrode material is problematic for safety reasons. More particularly, when lithium is deposited in the course of the charging operation, lithium dendrites form on the anode material. These can lead to a short circuit in the cell and as a result cause uncontrolled destruction of the cell.

EP 692 833 describes a carbon-containing insertion compound which, as well as carbon, comprises a metal or semimetal which forms alloys with lithium, especially silicon. The preparation is effected by pyrolysis of polymers which comprise the metal or semimetal and hydrocarbyl groups, for example in the case of silicon-containing inclusion compounds by pyrolysis of polysiloxanes. The pyrolysis requires severe conditions under which the primary polymers are first decomposed and then carbon and (semi)metal and/or (semi)metal oxide domains are formed. The production of such materials generally leads to qualities of poor reproducibility, probably because the high energy input makes control of the domain structure possible only with difficulty, if at all.

I. Honma et al., Nano Lett., 9 (2009), describe nanoporous materials formed from SnO₂ nanoparticles embedded between exfoliated graphite sheets. These materials are suitable as anode materials for Li ion batteries. They are produced by mixing exfoliated graphite sheets with SnO₂ nanoparticles in ethylene glycol. The exfoliated graphite sheets were themselves produced by reduction of oxidized and exfoliated graphite. This process is comparatively inconvenient and costly. In addition, this process leads to results with poor reproducibility.

WO 2010/112580 describes electroactive materials which comprise a carbon phase C and at least one MOₓ phase in which M is a metal or semimetal, for example boron, silicon, titanium or tin, x is a number from 0 to <k/2 where k is the maximum valency of the metal or semimetal. According to WO 2010/112580, the electroactive materials are produced in two stages, a first stage involving production of a nanocomposite material from a (semi)metal oxide phase and an organic polymer phase by what is called twin polymerization, and a second stage carbonization of the nanocomposite material thus produced. While this process in most cases leads to very good results, the monomers in the case of tin are difficult to obtain and can also be polymerized only with difficulty, and so the resulting polymer composite materials and the tin-carbon composite materials produced therefrom do not have satisfactory electrochemical properties.

WO 2010/112581 describes a process for producing the nanocomposite materials, in which metal- or semimetal-containing monomers are copolymerized. The monomers proposed include tin-containing monomers in which tin is present in the +4 oxidation state. The production of these monomers, especially in relatively large amounts, is difficult, and polymerization is problematic.

In summary, it can be stated that the anode materials which are based on carbon or based on lithium alloys and are known to date from the prior art are unsatisfactory in terms of specific capacity, charging/discharging kinetics and/or cycling stability, for example decrease in capacity and/or high or increasing impedance after several charging/discharging cycles. The composite materials which have a particulate semimetal or metal phase and one or more carbon phases and have been proposed recently to solve these problems are capable of solving these problems only partially, and the quality of such composite materials, at least in the case of tin-containing materials, cannot be achieved in a reproducible manner. In addition, the production thereof is generally so complex that economic utilization is impossible.

It is therefore an object of the present invention to provide a process for production of tin-containing polymer composite materials, which provides these materials with low complexity and product quality of good reproducibility which allows further processing in tin-carbon composite materials. The tin-carbon composite materials thus prepared should be suitable as anode material for Li ion batteries, especially for Li ion secondary batteries, and remedy the disadvantages of the prior art and should especially have at least one and especially more than one of the following properties:
high specific capacity,
high cycling stability,
low self-discharge,
good mechanical stability.

It has been found that these objects are surprisingly achieved by the processes elucidated in detail hereinafter for production of a tin oxide-containing polymer composite material composed of at least one inorganic tin oxide phase and an organic polymer phase, and the tin oxide-containing polymer composite materials obtainable by this process.

The present invention accordingly relates to a process for producing a tin oxide-containing polymer composite material composed of

a) at least one inorganic tin oxide phase; and

b) an organic polymer phase;

said process comprising the polymerization of at least one monomer of the formula I

R¹—X—Sn—Y—R² (I)
in which
R¹ is an Ar—C(R^{a},R^{b})— radical in which Ar is an aromatic or heteroaromatic ring which optionally has 1 or 2 substituents selected from halogen, OH, CN, C₁-C₆-alkyl, C₁-C₆-alkoxy and phenyl, and R^{a}, R^{b} are each independently hydrogen or methyl or together are an oxygen atom or a methylidene group (═CH₂);
R² is C₁-C₁₀-alkyl or C₃-C₈-cycloalkyl or has one of the definitions given for R¹; or
R¹ together with R² is a radical of the formula A:

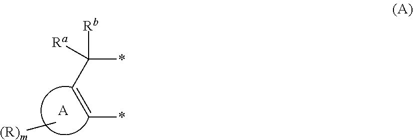

in which A is an aromatic or heteroaromatic ring fused to the double bond, m is 0, 1 or 2, the R radicals may be the same or different and are selected from halogen, CN, C₁-C₆-alkyl, C₁-C₆-alkoxy and phenyl, and R^{a}, R^{b} are each as defined above;
X is O, S or NH;
Y is O, S or NH;

under polymerization conditions under which both the Ar—C(R^{a},R^{b}) radicals polymerize to form the organic polymer phase and the XSnY unit to form the tin oxide phase.

The monomers of the formula I are novel and therefore likewise form part of the subject matter of the present invention. In contrast to the known tin(IV) compounds, they are easy to prepare, and they can also be prepared on the industrial scale. In addition, they are more stable than corresponding tin(IV) compounds, and so the use thereof in the polymerization is associated with fewer problems.

The invention also provides a tin oxide-containing polymer composite material composed of

a) at least one inorganic tin oxide phase; and

b) an organic polymer phase;

which is obtainable by the process according to the invention.

The inventive tin oxide-containing polymer composite materials can be converted in a simple manner to tin-carbon composite materials, by carbonizing the organic polymer phase of the tin oxide-containing polymer composite materials obtainable in accordance with the invention in a manner known per se.

The invention also provides a process for producing a tin-carbon composite material composed of at least one inorganic tin-containing phase in which the tin is present in the 0 or +2 oxidation state or in the form of a mixture thereof; and of a carbon phase in which carbon is present in elemental form; comprising
i. the provision of a tin oxide-containing polymer composite material by the process described here and hereinafter and
ii. carbonization of the organic polymer phase of the tin oxide-containing polymer composite material obtained in step i.

The invention further provides the tin-carbon composite material which is obtainable by this process and is composed of at least one inorganic tin-containing phase in which the tin is present in the +2 or 0 oxidation state or in the form of a mixture thereof; and of a carbon phase in which carbon is present in elemental form.

Due to its composition, and the specific arrangement of the carbon phase C and of the tin-containing phase resulting from the production, the tin-carbon composite material is particularly suitable as an electroactive material for anodes in Li ion cells, especially in Li ion secondary cells or batteries. More particularly, in the case of use in anodes of Li ion cells and especially of Li ion secondary cells, it is notable for a high capacity and a good cycling stability, and ensures low impedances in the cell. Moreover, probably because of the co-continuous phase arrangement, it has a high mechanical stability. In addition, it can be produced in a simple manner and with reproducible quality.

The invention therefore also provides for the use of the tin-carbon composite material in anodes for lithium ion cells, especially lithium ion secondary cells, and an anode for lithium ion cells, especially lithium ion secondary cells, which comprises an inventive tin-carbon composite material, and a lithium ion cell, especially a lithium ion secondary cell, which has at least one anode comprising an inventive tin-carbon composite material.

Preferred embodiments of the processes according to the invention and of the tin oxide-containing polymer composite materials and tin-carbon composite materials obtainable therein are elucidated in detail here and in the claims.

In the context of the invention, a tin oxide-containing polymer composite material is understood to mean a material which consists essentially, generally to an extent of at least 90% by weight, especially to an extent of at least 95% by weight, of tin oxide and an organic polymer phase, the phases being present distributed among one another. The tin oxide phase generally consists essentially, i.e. generally to an extent of at least 90% by weight, especially to an extent of at least 95% by weight, of tin oxide or tin oxide hydrates. The organic polymer phase is formed by a carbon-containing polymer other then elemental carbon. The composition of the organic polymer phase is defined by the Ar—C(R^{a},R^{b}) groups, and so it typically comprises poly(het)arylformaldehyde condensates or polyarylcarbonates or mixtures thereof.

The term “tin oxide” in the context of the invention comprises the pure tin oxides of the stoichiometry SnO, e.g. α-SnO and β-SnO, Sn₂O₃ and SnO₂, e.g. octagonal SnO₂ and hexagonal SnO₂, and oxide hydrates of dib- and tetravalent tin such as Sn(OH)₂ and stannic acid H₂Sn(OH)₆.

In the context of the invention, a carbon-tin composite material is understood to mean a material which consists essentially, generally to an extent of at least 90% by weight, especially to an extent of at least 95% by weight, of a tin-containing phase and elemental carbon, the tin-containing phase on the one hand and carbon on the other hand being present distributed among one another. The carbon phase is formed by elemental carbon, and the carbon may have graphitic structural units.

The terms “alkyl”, “alkoxy”, “cycloalkyl” and “hydroxyalkyl” should, just like the terms “aromatic ring” and “heteroaromatic ring”, be understood as generic collective terms which cover the substituents typically described by this term. In this context, the suffix Cₙ-Cₘ indicates the possible number of carbon atoms that the substituents summarized by this collective term may have.

Alkyl is accordingly a saturated linear or branched aliphatic hydrocarbyl radical having generally 1 to 10, frequently 1 to 6 and especially 1 to 4 carbon atoms. Examples of alkyl are methyl, ethyl, n-propyl, isopropyl, n-butyl, 2-butyl, 2-methylpropyl, 1,1-dimethylethyl(=tert-butyl), n-pentyl, 2-pentyl, 2-methylbutyl, n-hexyl, 2-hexyl, n-heptyl, 2-heptyl, n-octyl, 2-octyl, 2-ethylhexyl, n-nonyl, n-decyl, 1-methylnonyl and 2-propylheptyl.

Alkoxy is accordingly a saturated linear or branched aliphatic hydrocarbyl radical which is bonded via an oxygen atom and has generally 1 to 10, frequently 1 to 6 and especially 1 to 4 carbon atoms. Examples of alkoxy are methoxy, ethoxy, n-propoxy, isopropoxy, n-butyloxy, 2-butyloxy, 2-methylpropoxy, 1,1-dimethylethoxy(=tert-butoxy), n-pentyloxy, 2-pentyloxy, 2-methylbutoxy, n-hexyloxy, 2-hexyloxy, n-heptyloxy, 2-heptyloxy, n-octyloxy, 2-octyloxy, 2-ethylhexyloxy, n-nonyloxy, n-decyloxy, 1-methylnonyloxy and 2-propylheptyloxy.

Hydroxyalkyl is accordingly a saturated aliphatic hydrocarbyl radical which is substituted by at least one OH group and has generally 1 to 10, frequently 1 to 6 and especially 1 to 4 carbon atoms. Examples of hydroxyalkyl are hydroxymethyl, 1-hydroxyethyl, 2-hydroxyethyl, 1-hydroxypropyl, 2-hydroxypropyl, 3-hydroxylpropyl, 1-hydroxy-1-methylethyl, 2-hydroxy-1-methylethyl, 4-hydroxybutyl etc.

Cycloalkyl is accordingly a saturated cycloaliphatic hydrocarbyl radical which has generally 3 to 10, frequently 3 to 8 and especially 3 to 6 carbon atoms and is optionally substituted by 1 to 4 methyl groups. Examples of cycloalkyl are cyclopropyl, cyclobutyl, cyclopentyl, cyclohexyl, cyclooctyl, 1-methylcyclopropyl, 2-methylcyclopropyl, 1-, 2- or 3-methylcyclopentyl, 1-, 2-, 3- or 4-methylcyclohexyl, 1,2-dimethylcyclohexyl, 1,3-dimethylcyclohexyl, 2,3-dimethylcyclohexyl, 2,2-dimethylcyclohexyl, 3,3-dimethylcyclohexyl, 4,4-dimethylcyclohexyl, etc.

In the context of the invention, an aromatic radical is understood to mean a carbocyclic aromatic hydrocarbyl radical such as phenyl or naphthyl.

In the context of the invention, a heteroaromatic radical is understood to mean a heterocyclic aromatic radical which generally has 5 or 6 ring members, one of the ring members being a heteroatom selected from nitrogen, oxygen and sulfur, and 1 or 2 further ring members optionally being a nitrogen atom and the remaining ring members being carbon. Examples of heteroaromatic radicals are furyl, thienyl, pyrrolyl, pyrazolyl, imidazolyl, oxazolyl, isoxazolyl, pyridyl and thiazolyl.

In the context of the invention, a fused aromatic radical or ring is understood to mean a carbocyclic aromatic divalent hydrocarbylene radical such as o-phenylene (benzo) or 1,2-naphthylene(naphtho).

In the process according to the invention, tin-containing monomers of the formula I are polymerized under reaction conditions under which both the Ar—C(R^{a},R^{b}) radicals polymerize to form the organic polymer phase and the XSnY unit to form the tin oxide phase. Such polymerization reactions are referred to as twin polymerization and are known, for example, from WO 2010/112580 and WO 2010/112581. In contrast to the process according to the invention, WO 2010/112580 and WO 2010/112581 propose exclusively those monomers in which tin is in the +4 oxidation state.

In the process according to the invention, preference is given to using those monomers of the formula I in which at least one of the variables X and Y and especially both variables X and Y is/are oxygen.

In the process according to the invention, preference is given to using those monomers of the formula I in which R^{a} and R^{b} in the Ar—C(R^{a},R^{b})— unit or in the radical of the formula A are each hydrogen.

In the process according to the invention, preference is given to using those monomers of the formula I in which R¹ and R² are the same or different and are each a radical of the formula Ar—C(R^{a},R^{b})—, preference being given to those radicals of the formula in which R^{a} and R^{b} are each hydrogen. When R¹ and R² are each an Ar—C(R^{a},R^{b})— radical, Ar is preferably an aromatic or heteroaromatic radical selected from phenyl and furyl, where phenyl and furyl are unsubstituted or have 1 or 2 substituents selected from halogen, OH, CN, C₁-C₆-alkyl, C₁-C₆-alkoxy, C₁-C₆-hydroxyalkyl and phenyl. More particularly, Ar is phenyl or furyl, where phenyl and furyl are each unsubstituted or optionally have 1 or 2 substituents selected from C₁-C₆-alkyl, C₁-C₆-hydroxyalkyl and C₁-C₆-alkoxy, and especially from hydroxymethyl, methyl and methoxy. In a preferred embodiment, Ar is phenyl which is unsubstituted or especially has 1 or 2 substituents selected from C₁-C₆-alkyl and C₁-C₆-alkoxy and especially from methyl and methoxy. Examples of particularly preferred Ar groups are methoxyphenyl or 2,4-dimethoxyphenyl. R¹ and R² are especially each independently (methoxyphenyl)methyl or (2,4-dimethoxyphenyl)methyl.

In a further embodiment of the monomers of the formula I, the R¹ and R² groups together are a radical of the formula A, as defined above, especially a radical of the formula Aa:

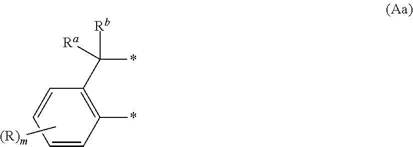

in which #, m, R, R^{a} and R^{b} are each as defined above. In the formulae A and Aa, the variable m is especially 0. When m is 1 or 2, R is especially a hydroxymethyl, methyl or methoxy group. In the formulae A and Aa, R^{a} and R^{b} are especially each hydrogen.

The monomers of the formula I can be prepared in analogy to processes known per se for preparation of organotin compounds. In general, monomers or compounds of the formula I in which R¹ is an Ar—C(R^{a},R^{b})— radical will be prepared by reacting a suitable tin(II) compound, for example a tin(II) halide such as tin(II) chloride or a tin(II) alkoxide, e.g. tin(II) methoxide (Sn(OCH₃)₂), with a compound of the formula Ar—C(R^{a},R^{b})—XH or a mixture of different compounds of the formula Ar—C(R^{a},R^{b})—XH or Ar—C(R^{a},R^{b})—YH, in which Ar, X, Y, R^{a} and R^{b} are each as defined above. In the case of use of tin(II) halides, the reaction is typically effected in the presence of a tertiary amine as a base. Typically, the compounds of the formula Ar—C(R^{a},R^{b})—XH or Ar—C(R^{a},R^{b})—YH are used in excess, based on the desired stoichiometry of the reaction.

In an analogous manner, monomers or compounds of the formula I in which R¹ is an Ar—C(R^{a},R^{b})— radical will be prepared by reacting a suitable tin(II) compound, for example a tin(II) halide such as tin(II) chloride or a tin(II) alkoxide, e.g. tin(II) methoxide (Sn(OCH₃)₂), with a compound of the formula AXHYH

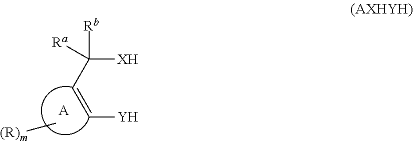

in which m, A, X, Y, R, R^{a} and R^{b} are each as defined above. In the case of use of tin(II) halides, the reaction is effected typically in the presence of a tertiary amine as a base. Typically, the compound AXHYH is used in excess, based on the desired stoichiometry of the reaction.

To produce the polymer composite material, a monomer of the formula I (also referred to hereinafter as monomer I) can be polymerized alone (homopolymerization). It is also possible to copolymerize mixtures of different monomers I. It is also possible to copolymerize one or more monomers I with substances known to be suitable for copolymerization with the R¹ or R² radicals. These include in particular aliphatic, aromatic or heteroaromatic aldehydes such as benzaldehyde, furfural, formaldehyde or acetaldehyde, preference being given to using formaldehyde in gaseous form or in a nonaqueous oligomeric or polymeric form, for example in the form of trioxane or paraformaldehyde. It is likewise possible to copolymerize the inventive monomers I with other monomers which are copolymerizable under the conditions of a twin polymerization and comprise oxide-forming semimetals, as described, for example, in WO 2010/112580 and WO 2010/112581, and which may have a metal or semimetal other than tin. These include, in particular, the monomers of the general formula I described in WO 2010/112580 and WO 2010/112581, hereinafter formula X

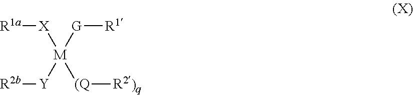

in which
M is a metal or semimetal, preferably a metal or semimetal of main group 3 or 4 or of transition group 4 or 5 of the Periodic Table, especially B, Al, Si, Ti, Zr, Hf, Ge, Sn, Pb, V, As, Sb or Bi, more preferably B, Si, Ti, Zr or Sn, even more preferably Si or Ti and especially Si;
R₁ₐ, R^{2a} may be the same or different and are each an Ar—C(R^{a},R^{b})— radical in which Ar, R^{a}, R^{b} are each as defined above in connection with formula I, especially the definitions cited as preferred,
   or the R^{1a}X and R^{2a}Y radicals together are a radical of the formula A′

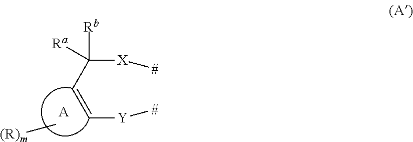

in which A, R, m, Ra, R^{b} are each as defined above in connection with formula I, especially the definitions cited as preferred;
X is O, S or NH and especially O;
Y is O, S or NH and especially O;
q according to the valency or charge of M is 0, 1 or 2 and especially 1,
G, Q may be the same or different and are each O, S, NH or a chemical bond and especially oxygen or a chemical bond;
R^{1′}, R^{2′} may be the same or different and are each C₁-C₆-alkyl, C₃-C₆-cycloalkyl, aryl or an Ar′—C(R^{a′},R^{b′})— radical in which Ar' is as defined for Ar, and R^{a′}, R^{b′} are each as defined for R^{a}, R^{b} and are especially each hydrogen, or R^{1′}, R^{2′} together with G and Q are a radical of the formula A′ as defined above;

and especially the monomers of the general formulae II, IIa, III, IIIa, IV, V, Va, VI or VIa described in WO 2010/112580 and WO 2010/112581.

In a preferred embodiment, the proportion of the monomers other than the monomers of the formula I, for example the monomers of the formula X or the aforementioned aldehydes, will not exceed 20% by weight and especially 10% by weight, based on the total amount of the monomers to be polymerized, i.e. the monomers of the formula I make up at least 80% by weight and especially at least 90% by weight of the total amount of the monomers to be polymerized. In another embodiment of the invention, the proportion of the monomers of the formula I in the total amount of the monomers to be polymerized makes up 20 to 80% by weight, especially 30 to 70% by weight, and the proportion of the monomers other than the monomers of the formula I, for example the monomers of the formula X or the aforementioned aldehydes, is in the range from 20 to 80% by weight and especially in the range from 30 to 70% by weight, based on the total amount of the monomers to be polymerized.

The monomers of the formula I can be polymerized and copolymerized with different monomers in analogy to the processes described in WO 2010/112580 and WO 2010/112581.

In a preferred embodiment of the process according to the invention, the monomers I are polymerized in an organic solvent or solvent mixture, especially in an organic aprotic solvent or solvent mixture. Preference is given to those aprotic solvents in which the polymer composite material formed is insoluble (solubility <1 g/l at 25° C.). As a result, particularly small particles of the polymer composite material are formed under polymerization conditions. However, the polymerization can also be effected in substance.

It is assumed that the use of aprotic solvent in which the polymer composite material formed in the polymerization is insoluble promotes particle formation in principle. If the polymerization is performed in the presence of a particulate inorganic material, the formation of the particles will probably be controlled by the presence of the particulate inorganic material, and this will prevent the formation of a coarse polymer composite material.

The aprotic solvent is preferably selected such that the monomer I is at least partly soluble. This is understood to mean that the solubility of the monomer I in the solvent under polymerization conditions is at least 50 g/l, especially at least 100 g/l. In general, the organic solvent is selected such that the solubility of the monomers at 20° C. is 50 g/l, especially at least 100 g/l. More particularly, the solvent is selected such that the monomers I are substantially or completely soluble therein, i.e. the ratio of solvent to monomer I is selected such that, under polymerization conditions, at least 80%, especially at least 90% or the entirety of the monomers I is present in dissolved form.

“Aprotic” means that the solvent used for polymerization comprises essentially no solvents which have one or more protons which are bonded to a heteroatom such as O, S or N and are thus more or less acidic. The proportion of protic solvents in the solvent or solvent mixture used for the polymerization is accordingly less than 10% by volume, particularly less than 1% by volume and especially less than 0.1% by volume, based on the total amount of organic solvent. The polymerization of the monomers I is preferably performed in the substantial absence of water, i.e. the concentration of water at the start of the polymerization is less than 500 ppm, based on the amount of solvent used.

The solvent may be inorganic or organic or be a mixture of inorganic and organic solvents. It is preferably an organic solvent.

Examples of suitable aprotic organic solvents are halohydrocarbons such as dichloromethane, chloroform, dichloroethane, trichloroethane, 1,2-dichloroethane, 1,1,1-trichloroethane, 1-chlorobutane, chlorobenzene, dichlorobenzenes, fluorobenzene, and also pure hydrocarbons, which may be aliphatic, cycloaliphatic or aromatic, and mixtures thereof with halohydrocarbons. Examples of pure hydrocarbons are acyclic aliphatic hydrocarbons having generally 2 to 8 and preferably 3 to 8 carbon atoms, especially alkanes such as ethane, iso- and n-propane, n-butane and isomers thereof, n-pentane and isomers thereof, n-hexane and isomers thereof, n-heptane and isomers thereof, and n-octane and isomers thereof, cycloaliphatic hydrocarbons such as cycloalkanes having 5 to 8 carbon atoms, such as cyclopentane, methylcyclopentane, cyclohexane, methylcyclohexane, cycloheptane, and aromatic hydrocarbons such as benzene, toluene, xylenes, mesitylene, ethylbenzene, cumene (2-propylbenzene), isocumene (1-propylbenzene) and tert-butylbenzene. Preference is also given to mixtures of the aforementioned hydrocarbons with halogenated hydrocarbons, such as halogenated aliphatic hydrocarbons, for example such as chloromethane, dichloromethane, trichloromethane, chloroethane, 1,2-dichloroethane and 1,1,1-trichloroethane and 1-chlorobutane, and halogenated aromatic hydrocarbons such as chlorobenzene, 1,2-dichlorobenzene and fluorobenzene.

Examples of inorganic aprotic solvents are especially supercritical carbon dioxide, carbon oxide sulfide, carbon disulfide, nitrogen dioxide, thionyl chloride, sulfuryl chloride and liquid sulfur dioxide, the three latter solvents also being able to act as polymerization initiators.

The monomers I are typically polymerized in the presence of a polymerization initiator or catalyst. The polymerization initiator or catalyst is selected such that it initiates or catalyzes a cationic polymerization of the monomers I, i.e. of the monomer units XR¹ and YR², and the formation of the tin oxide phase. Accordingly, in the course of polymerization of the monomers I, the monomer units XR¹ and YR² on the one hand polymerize and the tin oxide phase on the other hand forms synchronously. The term “synchronously” does not necessarily mean that the polymerization of the monomer units XR¹ and YR² and the formation of the tin oxide phase proceed at the same rate. Instead, “synchronously” means that these processes are coupled kinetically and are triggered by the cationic polymerization conditions.

Suitable polymerization initiators or catalysts are in principle all substances which are known to catalyze cationic polymerizations. These include protic acids (Brnsted acids) and aprotic Lewis acids. Preferred protic catalysts are Brnsted acids, for example organic carboxylic acids, for example trifluoroacetic acid, oxalic acid or lactic acid, and especially organic sulfonic acids such as methanesulfonic acid, trifluoromethane-sulfonic acid or toluenesulfonic acid. Likewise suitable are inorganic Brnsted acids such as HCl, H₂SO₄ or HClO₄. The Lewis acids used may, for example, be BF₃, BCl₃, SnCl₄, TiCl₄, or AlCl₃. The use of Lewis acids bound in complex form or dissolved in ionic liquids is also possible. The polymerization initiator or catalyst is used typically in an amount of 0.1 to 10% by weight, preferably 0.5 to 5% by weight, based on the monomer M.

The temperatures required for the polymerization of the monomers I are typically in the range from 0 to 150° C., particularly in the range from 20 to 140° C. and especially in the range from 40 to 120° C.

The process according to the invention is especially suitable for industrial production of tin oxide-containing polymer composite materials in continuous and/or batchwise mode. In batchwise mode, this means batch sizes of at least 10 kg, frequently at least 100 kg, especially at least 1000 kg or at least 5000 kg. In continuous mode, this means production volumes of generally at least 100 kg/day, frequently at least 1000 kg/day, especially at least 10 t/day or at least 100 t/day.

The tin oxide-containing polymer composite materials obtainable by the process according to the invention consist essentially, i.e. generally to an extent of at least 90% by weight, especially to an extent of at least 95% by weight, of tin oxide and an organic polymer phase. The tin oxide phase generally consists essentially, i.e. generally to an extent of at least 90% by weight, especially to an extent of at least 95% by weight, of tin oxide or tin oxide hydrates. The tin oxide here is preferably present to an extent of at least 80% and especially to an extent of at least 90% in the form of tin in the +2 oxidation state. The organic polymer phase is formed by a carbonaceous polymer other than elemental carbon. The composition of the organic polymer phase is defined by the Ar—C(R^{a},R^{b}) groups, and so they are typically poly(het)arylformaldehyde condensates or polyaryl carbonates or mixtures thereof.

Another result of the process according to the invention is that the tin oxide phase and the organic polymer phase are present in a co-continuous arrangement over wide ranges, which means that the respective phase essentially does not form any isolated phase domains surrounded by an optionally continuous phase domain. Instead, the two phases form spatially separate continuous phase domains which penetrate one another, as can be seen by examining the materials by means of transmission electron microscopy. With regard to the terms “continuous phase domains”, “discontinuous phase domains” and “co-continuous phase domains”, reference is also made to W. J. Work et al., Definitions of Terms Related to Polymer Blends, Composites and Multiphase Polymeric Materials, (IUPAC Recommendations 2004), Pure Appl. Chem., 76 (2004), p. 1985-2007, especially p. 2003. Accordingly, a co-continuous arrangement of a two-component mixture is understood to mean a phase-separated arrangement of the two phases or components, in which within one domain of the particular phase a continuous path through either phase domain may be drawn to all phase boundaries without crossing any phase domain boundary.

In the inventive polymer composite materials, the regions in which the organic polymer phase and the tin oxide phase form essentially co-continuous phase domains make up at least 50% by volume, frequently at least 80% by volume and especially at least 90% by volume of the polymer composite material.

In the inventive polymer composite materials, the distances between adjacent phase interfaces, or the distances between the domains of adjacent identical phases, are small and are on average not more than 100 nm, particularly not more than 20 nm and especially not more than 10 nm. The distance between adjacent identical phases is, for example, the distance between two domains of the tin oxide phase separated from one another by a domain of the organic polymer phase, or the distance between two domains of the organic polymer phase separated from one another by a domain of the tin oxide phase. The mean distance between the domains of adjacent identical phases can be determined by means of small-angle x-ray scattering (SAXS) via the scatter vector q (measurement in transmission at 20° C., monochromatized CuK_{α} radiation, 2D detector (image plate), slit collimation).

The size of the phase regions and hence the distances between adjacent phase interfaces and the arrangement of the phase can also be determined by transmission electron microscopy, especially by means of the HAADF-STEM technique (HAADF-STEM=high angle annular darkfield scanning electron microscopy). In this imaging technique, comparatively heavy elements (for example Sn relative to C) appear brighter than lighter elements. Preparation artifacts can likewise be seen since denser regions of the preparations appear brighter than less dense regions.

As already mentioned above, the present invention also relates to the production of tin-carbon composite materials from at least one inorganic tin-containing phase in which tin is present in the form of tin in the +2 or 0 oxidation state, especially in elemental form or in the form of tin(II) oxide or Sn(II) oxide hydrates, or in the form of a mixture thereof. For this purpose, in a first step i., a tin oxide-containing polymer composite material is provided by the process described above. This tin oxide-containing polymer composite material is carbonized in a second step. The organic polymer phase is converted here to a phase consisting essentially of elemental carbon. The phase structure is essentially preserved.

For this purpose, the polymer composite material obtained in step i. is typically heated with substantial exclusion of oxygen to temperatures of at least 400° C., preferably at least 500° C., especially of at least 700° C., for example to temperatures in the range from 400 to 1800° C., preferably in the range from 500 to 1500° C., especially in the range from 700 to 1200° C. “With substantial exclusion of oxygen” means that the partial oxygen pressure in the reaction zone in which the carbonization is performed is low and will preferably not exceed 20 mbar, especially 10 mbar.

In one embodiment of the invention, the carbonization is performed in an inert gas atmosphere, for example under nitrogen or argon. The inert gas atmosphere will preferably comprise less than 1% by volume and especially less than 0.1% by volume of oxygen. In another embodiment of the invention, the carbonization is performed in the presence of so-called reducing gases. The reducing gases include, as well as hydrogen (H₂), hydrocarbon gases such as methane, ethane or propane, or ammonia (NH₃). The reducing gases can be used as such or as a mixture with an inert gas such as nitrogen or argon.

The particulate composite material is preferably used for carbonization in the form of a dry, i.e. substantially solvent-free, powder. “Solvent-free” means here and hereinafter that the composite material comprises less than 1% by weight, especially less than 0.1% by weight, of solvent.

Optionally, the carbonization is performed in the presence of an oxidizing agent which promotes the formation of graphite, for example of a transition metal halide such as iron trichloride. This achieves the effect that the carbon in the inventive carbon material is predominantly in the form of graphite or graphene units, i.e. in the form of polycyclic fused structural units in which each carbon atom forms covalent bonds to three further carbon atoms. The amount of such oxidizing agents is generally 1 to 20% by weight, based on the polymer composite material. When such an oxidizing agent is used in the carbonization, the procedure is typically to mix the polymer composite material and the oxidizing agent with one another and to carbonize the mixture in the form of a substantially solvent-free powder. The oxidizing agent is optionally removed after the carbonization, for example by washing the oxidizing agent out, for example using a solvent or solvent mixture in which the oxidizing agent and reaction products thereof are soluble, or by vaporization.

In this way, in step ii., a preferably particulate tin-carbon composite material composed of a carbon phase and at least one tin phase is obtained. The inventive carbon-tin composite material consists generally to an extent of at least 90% by weight, especially to an extent of at least 95% by weight, of at least one tin phase and of elemental carbon. The tin-containing phase consists generally essentially, i.e. generally to an extent of at least 90% by weight, especially to an extent of at least 95% by weight, of tin or tin oxide or tin oxide hydrates or a mixture thereof.

According to the invention, the tin-carbon composite material comprises a carbon phase (hereinafter also C phase) in which the carbon is present essentially in elemental form, which means that the proportion of the non-carbon atoms in the carbon phase, e.g. N, O, S, P and/or H, is less than 10% by weight, especially less than 5% by weight, based on the total amount of carbon in the C phase. The content of non-carbon atoms in the C phase can be determined by means of x-ray photoelectron spectroscopy. In addition to carbon, the C phase may, as a result of the preparation, especially comprise small amounts of nitrogen, oxygen, sulfur and/or hydrogen. The molar ratio of hydrogen to carbon will generally not exceed a value of 1:3, particularly a value of 1:5 and especially a value of 1:10. The value may also be 0 or virtually 0, e.g. ≦0.1. In the C phase, the carbon is probably present predominantly in amorphous or graphitic form. The presence of amorphous or graphitic carbon can be determined by means of ESCA studies with reference to the characteristic binding energy (284.5 eV) and the characteristic asymmetric signal shape. Carbon in graphitic form is understood to mean that the carbon is at least partly in a hexagonal layer arrangement typical of graphite, where the layers may also be curved or exfoliated.

In addition to the C phase, the inventive tin-carbon composite material comprises at least one tin phase (Sn phase), the tin in the tin phase being in the +2 or 0 oxidation state or in a mixed form thereof. The Sn phase preferably consists essentially of elemental tin or tin(II) oxide or tin(II) oxide hydrates such as tin(II) hydroxide or a mixture thereof. In the Sn phase, the proportion of non-tin and -oxygen atoms, for example other metals or semimetals and N, S, P and/or H, is preferably less than 10% by weight, especially less than 5% by weight, based on the total amount of carbon in the Sn phase. In the Sn phase, the tin may be in the form of tin in the +2 oxidation state or in the form of elemental tin, i.e. tin in the 0 oxidation state, or in the form of a mixed form thereof. In a preferred embodiment, the tin is predominantly in the 0 oxidation state, which means that at least 50%, especially at least 80% or at least 90% of the tin atoms of the Sn phase are in the 0 oxidation state and especially in the form of elemental tin.

In general, the C phase and the Sn phase form essentially co-continuous phase domains with irregular arrangement, the mean distance between two adjacent domains of the Sn phase, or the mean distance between two adjacent domains of the C phase, being not more than 100 nm, particularly not more than 20 nm, especially not more than 10 nm, and being, for example, in the range from 0.5 to 100 nm, particularly 0.7 to 20 nm and especially 1 to 10 nm. With regard to the determination of the mean distances between two adjacent domains of the Sn phase or of the C phase, the statements made above for the polymer composite material obtained in step i. apply in the same way.

In a further embodiment, the Sn phase is in the form of Sn domains which are embedded in an essentially isolated manner in a continuous carbon phase C as the matrix. In this embodiment, frequently more than 50% by volume of the Sn domains have a size in the range from 1 nm to 20 μm, especially 1 nm to 1 μm. More particularly, in these tin-carbon composite materials of this embodiment, the tin content is 5 to 90% by weight, preferably 10 to 75% by weight, more preferably 15 to 55% by weight, especially 20 to 40% by weight, based on the total mass of the tin-carbon composite materials.

The process according to the invention is especially suitable for industrial production of tin-carbon composite materials in continuous and/or batchwise mode. In batchwise mode, this means batch sizes of at least 10 kg, frequently at least 100 kg, especially at least 1000 kg or at least 5000 kg. In continuous mode, this means production amounts of generally at least 100 kg/day, frequently at least 1000 kg/day, especially at least 10 t/day or at least 100 t/day.

The inventive tin-carbon composite material is notable, as already stated, for particularly advantageous properties when employed in electrochemical cells, especially lithium ion cells, especially for a high specific capacity, good cycling stability, low tendency to self-discharge and to form lithium dendrites, and for advantageous kinetics with regard to the charging/discharging operation, such that high current densities can be achieved.

In the context of this invention, an electrochemical cell or battery is understood to mean batteries, capacitors and accumulators (secondary batteries) of any kind, especially alkali metal cells or batteries, for example lithium, lithium ion, lithium-sulfur and alkaline earth metal batteries and accumulators, specifically also in the form of high-energy or high-performance systems, and electrolytic capacitors and double layer capacitors known by the Supercaps, Goldcaps, BoostCaps or Ultracaps names.

The invention therefore also provides for the use of the tin-carbon composite material for production of electrochemical cells and more particularly for the use thereof in anodes for lithium ion cells, especially lithium ion secondary cells. The invention accordingly also relates to an anode for lithium ion cells, especially lithium ion secondary cells, which comprises an inventive tin-carbon composite material.

In addition to the inventive tin-carbon composite material, the anode generally comprises at least one suitable binder for consolidation of the inventive tin-carbon composite material and optionally of further electrically conductive or electroactive constituents. In addition, the anode generally has electrical contacts for supply and removal of charges. The amount of inventive tin-carbon composite material, based on the total mass of the anode material, minus any current collectors and electrical contacts, is generally at least 40% by weight, frequently at least 50% by weight and especially at least 60% by weight.

Suitable further conductive or electroactive constituents are known from relevant monographs (see, for example, M. E. Spahr, Carbon Conductive Additives for Lithium-Ion Batteries, in M. Yoshio et al. (eds.) Lithium Ion Batteries, Springer Science+Business Media, New York 2009, p. 117-154 and literature cited therein). Useful further electrically conductive or electroactive constituents in the inventive anodes include carbon black, graphite, carbon fibers, carbon nanofibers, carbon nanotubes or electrically conductive polymers. Typically, about 2.5 to 40% by weight of the conductive material are used in the anode together with 50 to 97.5% by weight, frequently with 60 to 95% by weight, of the inventive electroactive material, the figures in % by weight being based on the total mass of the anode material, minus any current collectors and electrical contacts.

Useful binders for the production of an anode using the aforementioned tin-carbon composite materials and further electroactive materials in principle include all prior art binders suitable for anode materials, as known from relevant monographs (see, for example, A. Nagai, Applications of PVdF-Related Materials for Lithium-Ion Batteries, in M. Yoshio et al. (eds.) Lithium Ion Batteries, Springer Science+Business Media, New York 2009, p. 155-162 and literature cited therein, and also H. Yamamoto and H. Mori, SBR Binder (for negative electrode) and ACM Binder (for positive electrode), ibid., p. 163-180). Useful binders include especially the following polymeric materials:

polyethylene oxide (PEO), cellulose, carboxymethylcellulose (CMC), polyethylene, polypropylene, polytetrafluorethylene, polyacrylonitrile-methyl methacrylate, polytetrafluoroethylene, styrene-butadiene copolymers, tetrafluoroethylene-hexafluoroethylene copolymers, polyvinylidene difluoride (PVdF), polyvinylidene difluoride hexafluoropropylene copolymers (PVdF-HFP), tetrafluoroethylene hexa-fluoropropylene copolymers, tetrafluoroethylene, perfluoroalkyl-vinyl ether copolymers, vinylidene fluoride-hexafluoropropylene copolymers, ethylene-tetrafluoroethylene copolymers, vinylidene fluoride-chlorotrifluoroethylene copolymers, ethylene-chloro-fluoroethylene copolymers, ethylene-acrylic acid copolymers (with and without inclusion of sodium ions), ethylene-methacrylic acid copolymers (with and without inclusion of sodium ions), ethylene-methacrylic ester copolymers (with and without inclusion of sodium ions), polyimides and polyisobutene.

The binder is optionally selected with consideration of the properties of any solvent used for the preparation. The binder is generally used in an amount of 1 to 10% by weight, based on the overall mixture of the anode material, i.e. tin-carbon composite material and optionally further electroactive or conductive materials. Preferably 2 to 8% by weight and especially 3 to 7% by weight are used.

The anode can be produced in a manner customary per se by standard methods as known from the prior art cited at the outset and from relevant monographs (see, for example, R. J. Brodd, M. Yoshio, Production processes for Fabrication of Lithium-Ion Batteries, in M. Yoshio et al. (eds.) Lithium Ion Batteries, Springer Science+Business Media, New York 2009, p. 181-194 and literature cited therein). For example, the anode can be produced by mixing the inventive electroactive material, optionally using an organic solvent (for example N-methylpyrrolidinone or a hydrocarbon solvent), with the optional further constituents of the anode material (electrically conductive constituents and/or organic binder), and optionally subjecting it to a shaping process or applying it to an inert metal foil, for example Cu foil. This is optionally followed by drying. This is done, for example, using a temperature of 80 to 150° C. The drying operation can also take place under reduced pressure and lasts generally for 3 to 48 hours. Optionally, it is also possible to employ a melting or sintering process for the shaping.

The present invention also provides lithium ion cells, especially lithium ion secondary cells which have at least one anode comprising an inventive tin-carbon composite material.

Such cells generally have at least one inventive anode, a cathode suitable for lithium ion cells, an electrolyte and optionally a separator.

With regard to suitable cathode materials, suitable electrolytes and suitable separators, and to possible arrangements, reference is made to the relevant prior art, for example the prior art cited at the outset, and to appropriate monographs and reference works: for example Wakihara et al. (editor) in Lithium Ion Batteries, 1st edition, Wiley VCH, Weinheim, 1998; David Linden: Handbook of Batteries (McGraw-Hill Handbooks), 3rd edition, McGraw-Hill Professional, New York 2008; J. O. Besenhard: Handbook of Battery Materials. Wiley-VCH, 1998; M. Yoshio et al. (ed.) Lithium Ion Batteries, Springer Science+Business Media, New York 2009; K. E. Aifantis, S. A. Hackney, R. V. Kumar, (ed.), High Energy Density Lithium Batteries, Wiley-VCH, 2010.

Useful cathodes include especially those cathodes in which the cathode material comprises at least one lithium-transition metal oxide, e.g. lithium-cobalt oxide, lithium-nickel oxide, lithium-cobalt-nickel oxide, lithium-manganese oxide (spinel), lithium-nickel-cobalt-aluminum oxide, lithium-nickel-cobalt-manganese oxide or lithium-vanadium oxide, or a lithium-transition metal phosphate such as lithium-iron phosphate. Useful cathode materials also include sulfur and sulfur-containing composite materials, for example sulfur-carbon composite materials as known for lithium-sulfur cells.

The two electrodes, i.e. the anode and the cathode, are connected to one another using a liquid or else solid electrolyte. Useful liquid electrolytes include especially nonaqueous solutions (water content generally <20 ppm) of lithium salts and molten Li salts, for example solutions of lithium hexafluorophosphate, lithium perchlorate, lithium hexafluoroarsenate, lithium trifluoromethylsulfonate, lithium bis(trifluoromethyl-sulfonyl)imide or lithium tetrafluoroborate, especially lithium hexafluorophosphate or lithium tetrafluoroborate, in suitable aprotic solvents, for example ethylene carbonate, propylene carbonate and mixtures thereof with one or more of the following solvents: dimethyl carbonate, diethyl carbonate, dimethoxyethane, methyl propionate, ethyl propionate, butyrolactone, acetonitrile, ethyl acetate, methyl acetate, toluene and xylene, especially in a mixture of ethylene carbonate and diethyl carbonate. The solid electrolytes used may, for example, be ionically conductive polymers.

A separator impregnated with the liquid electrolyte may be arranged between the electrodes. Examples of separators are especially glass fiber nonwovens and porous organic polymer films, such as porous films of polyethylene, polypropylene, PVdF etc.

These may have, for example, a prismatic thin film structure, in which a solid thin film electrolyte is arranged between a film which constitutes an anode and a film which constitutes a cathode. A central cathode output conductor is arranged between each of the cathode films in order to form a double-faced cell configuration. In another embodiment, it is possible to use a single-faced cell configuration in which a single cathode output conductor is assigned to a single anode/separator/cathode element combination. In this configuration, an insulating film is typically arranged between individual anode/separator/cathode/output conductor element combinations.

The figures and examples which follow serve to illustrate the invention and should not be understood in a restrictive manner.

The TEM analyses were HAADF-STEM analyses conducted with a Tecnai F20 transmission electron microscope (FEI, Eindhoven, The Netherlands) at a working voltage of 200 kV in the ultrathin layer technique (embedding of the samples into synthetic resin as a matrix).

The ESCA studies were conducted with a FEI 5500 LS x-ray photoelectron spectrometer from FEI (Eindhoven, The Netherlands).

The small-angle x-ray scattering analyses were affected at 20° C. in slit collimation using Cu_{K}_{_{α}} radiation monochromatized with Gobel mirrors. The data were collected against the background and sharpened in respect of the blurring caused by the slit collimation.

In relation to IR spectra, the abbreviations s, m and w stand for strong, moderate and weak, and indicate the relative intensity of the bands.

### I. PREPARATION OF THE MONOMERS I

### PREPARATION EXAMPLE 1

### Preparation of tin(II) bis(2-methoxyphenylmethoxide)

(Monomer I where X═Y═O; R¹═R²=2-methoxybenzyl)
a) 19.51 g (10.29 mol) of anhydrous SnCl₂ were dissolved in 250 ml of methanol. To this were added dropwise, at room temperature, 57 ml (41.16 mol) of dry triethylamine. A colorless precipitate formed immediately. After complete addition of the triethylamine, the reaction mixture was stirred for another 2 h and then the precipitate was filtered off. The resulting colorless solid was washed three times with 20 ml each time of methanol and then three times with 20 ml each time of diethyl ether. 17.67 g (97.74 mmol, 95%) of tin(II) methoxide (Sn(OCH₃)₂) were obtained in the form of an amorphous solid.

IR [cm⁻¹]: 2928 (m) (CH), 2828 (m) (CH), 1594 (s), 1486 (s), 1455 (s), 1362 (m), 1279 (m), 1233 (s), 1111 (s) (C—O), 1011 (s), 814 (m), 749 (s), 714 (m), 615 (s), 575 (s) (Sn—O), 478 (m), 432 (m).

EA determined (calculated): C: 48.6% (C: 48.9%), H: 5.0% (H: 4.6%).

¹H NMR (500.30 MHz, CDCl₃) δ [ppm]: 3.78 (s, 3H, CH₃O), 4.92 (s, 2 H, CH₂), 6.82 (d, 1H), 6.87 (dd, 1H), 7.23 (dd, 1H), 7.31 (d, 1H).

¹³C NMR (125.81 MHz, CDCl₃) δ [ppm]: 53.8 (CH₃O), 59.4 (CH₂), 108.8, 119.4, 127.0, 127.2, 128.4, 155.9.

¹¹⁹Sn NMR (186.53 MHz, CDCl₃) δ [ppm]: −160.

¹³C{¹H} CP-MAS NMR (100.62 MHz) δ [ppm]: 55.9 (CH₃O), 61.2 (CH₂), 109.3, 119.7, 125.5, 127.4, 131.7, 156.2.

¹¹⁹Sn{¹H} CP-MAS NMR (149.19 MHz) δ [ppm]: −351.
b) 3.00 g (16.59 mmol) of Sn(OCH₃)₂ were suspended in 50 ml of toluene. After addition of 4.82 g (34.85 mmol) of 2-methoxybenzyl alcohol, the suspension was heated and the methanol released was distilled off, in the course of which the suspended material dissolved. After concentration of the clear toluene solution to about 15 ml, a colorless solid precipitated out. This was washed repeatedly with diethyl ether and dried under high vacuum (10⁻³ mbar). 4.73 g (12.04 mmol, 72.5%) of the title compound were obtained in the form of a colorless solid which was identifiable on the basis of its IR spectrum or ¹H NMR spectrum.

### PREPARATION EXAMPLE 2

### Preparation of tin(II) bis(2,4-dimethoxyphenylmethoxide)

(Monomer I where X═Y═O; R¹═R²=2,4-dimethoxybenzyl)

2.00 g (11.06 mmol) of Sn(OCH₃)₂ were suspended in 50 ml of toluene. After addition of 3.91 g (23.25 mmol) of 2,4-dimethoxybenzyl alcohol, the suspension was heated and the methanol released was distilled off, in the course of which the suspended material dissolved. The resulting clear solution was concentrated until a white solid precipitated out. This was washed repeatedly with diethyl ether and dried under high vacuum (10⁻³ mbar). This gave 3.98 g (8.78 mmol, 79.4%) of the title compound in the form of a colorless solid.

IR [cm⁻¹]: 2936 (m) (CH), 2838 (m) (CH), 1590 (s), 1501 (s), 1457 (s), 1370 (m), 1285 (s), 1254 (m), 1204 (s), 1156 (s), 1123 (s) (0-0 v), 1032 (s), 986 (s), 932 (m), 822 (s), 731 (s), 695 (m), 627 (m), 571 (s) (Sn—O), 517 (m), 455 (s).

EA determined (calculated): C: 47.4% (C: 47.7%), H: 4.6% (H: 4.9%).

¹H NMR (500.30 MHz, CDCl₃) δ [ppm]: 3.75 (s, 3H, 4-MeO), 3.80 (s, 3H, 2-CH₃O), 4.76 (s, 2H, CH₂), 6.40 (dd, 2H), 7.20 (s, 1H).

¹³C NMR (125.81 MHz, CDCl₃) δ [ppm]: 55.3 (CH₃O), 60.6 (CH₂), 98.3, 103.8, 124.6, 130.1, 158.2, 160.3.

¹¹⁹Sn NMR (186.52 MHz, CDCl₃) δ [ppm]: −161, −269.

¹³C{¹H} CP-MAS NMR (100.62 MHz) δ [ppm]: 54.5 (CH₃O), 58.9 (CH₂), 97.0, 108.1, 126.3, 133.4, 158.4, 160.8.

¹¹⁹Sn{¹H} CP-MAS NMR (149.17 MHz) δ [ppm]: −350.

### PREPARATION EXAMPLE 3

### Preparation of tin(II) bis((2-thienyl)dimethylmethoxide)

(Monomer I where X═Y═O; R¹═R²=1-(2-thienyl)-1-methylethyl)

2.00 g (11.06 mmol) of Sn(OCH₃)₂ were suspended in 50 ml of toluene. After adding a solution of 3.15 g (22.12 mmol) of (2-thienyl)dimethylmethanol in 8 ml of toluene, the mixture was stirred at 23° C. for 1 h and then the methanol formed in the reaction was removed under reduced pressure. The resulting clear solution was concentrated to dryness. The recrystallization of the resulting colorless solid from diethyl ether afforded 3.24 g (8.07 mmol, 73%) of the title compound in the form of a colorless solid.

### PREPARATION EXAMPLE 4

### Preparation of 7-methoxybenzo[4H-1,3,2]dioxastannin

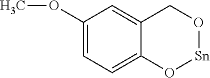

1.5 g (8.30 mmol) of Sn(OCH₃)₂ were suspended in 50 ml of toluene. After addition of 1.28 g (8.30 mmol) of 2-hydroxy-5-methoxybenzyl alcohol, the mixture was stirred at 23° C. for 1 h and then the methanol formed in the reaction was removed by distillation. The resulting clear solution was concentrated to dryness under reduced pressure. This gave a yellow solid, which was repeatedly washed thoroughly with diethyl ether and dried under high vacuum (10⁻³ mbar). This gave 1.83 g (6.72 mmol, 81%) of the title compound.

### PREPARATION EXAMPLE 5

### Preparation of 6-methoxybenzo[4H-1,3,2-]dioxastannin

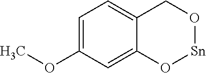

The preparation is effected analogously to preparation example 4, except that 2-hydroxy-4-methoxybenzyl alcohol was used in place of 2-hydroxy-5-methoxybenzyl alcohol.

Yield: 1.65 g (6.06 mmol, 73%).

EA determined (calculated): C: 34.7% (C: 35.5%), H: 3.1% (H: 3.0%).

IR [cm⁻¹]: 2933 (m) (CH), 2830 (m) (CH), 1601 (s), 1572 (s), 1489 (s), 1435 (s), 1273 (s), 1194 (s), 1154 (s), 1101 (s) (C—O v), 1032 (s), 957 (s), 832 (m), 789 (m), 735 (m), 488 (s) (Sn—O).

### PREPARATION EXAMPLE 6

### Preparation of 7-methylbenzo[4H-1,3,2-]dioxastannin

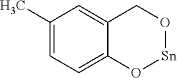

The preparation is effected analogously to preparation example 4, except that 2-hydroxy-5-methylbenzyl alcohol was used in place of 2-hydroxy-5-methoxybenzyl alcohol.

Yield: 1.68 g (6.60 mmol, 79.5%).

Production of the Polymer Composite Materials:

### EXAMPLE 1

0.5 g (1.27 mmol) of the compound from preparation example 1 (monomer 1) was dissolved in 16 ml of chloroform. While stirring, 10 mol %, based on monomer 1, of trifluoromethylsulfonic acid was added as a catalyst to the solution and the mixture was heated to 50° C. for 5 d. In the course of this, a solid precipitated out. The solid was filtered off with suction. After washing repeatedly with diethyl ether and drying under high vacuum (10⁻³ mbar), the polymer composite material was obtained as a colorless solid in a yield of 0.22 g (43%).

### EXAMPLE 2

In a manner analogous to example 1, 0.52 g of the compound from preparation example 1 was polymerized using 10 mol % of trifluoroacetic acid as a catalyst. The polymer composite material was obtained as a colorless solid in a yield of 0.06 g (12%).

### EXAMPLE 3

0.94 g (2.09 mmol) of the compound from preparation example 2 (monomer 2) was dissolved in 14 ml of chloroform. While stirring, 10 mol %, based on monomer 2, of trifluoromethylsulfonic acid was added as a catalyst to the solution, and the mixture was heated to 50° C. for 24 h. In the course of this, a solid precipitated out. The solid was filtered off with suction. After repeatedly washing with diethyl ether and drying under high vacuum (10⁻³ mbar), the polymer composite material was obtained as a colorless solid in a yield of 0.84 g (89%).

### EXAMPLE 4

In a manner analogous to example 1, 0.6 g of the compound from preparation example 2 was polymerized using 10 mol % of trifluoroacetic acid as a catalyst. The polymer composite material was obtained as a colorless solid in a yield of 0.19 g (32%).

### EXAMPLE 5

0.91 g of the compound from preparation example 5 were dissolved in 6 ml of dry chloroform and admixed with 10 mol % of trifluoromethanesulfonic acid dissolved in 2 ml of dry chloroform. The reaction mixture was stirred at room temperature for a further 3 days. Thereafter, the violet solid was filtered off and washed repeatedly with chloroform. Yield: 0.74 g (77%).

IR [cm⁻¹]: 3600-3050 (m) (OH), 2965 (w) (CH), 2840 (w) (CH), 1605 (m), 1497 (m), 1447 (m), 1223 (s), 1175 (s), 1092 (C—O v) (s), 1021 (s), 955 (m), 835 (m), 758 (m), 631 (s), 567 (m), 507 (m), 426 (s) (Sn—O).

1. A compound of the general formula I,
R¹—X—Sn—Y—R² (I)
in which
R¹ is an Ar—C(R^{a},R^{b}) radical in which Ar is an aromatic or heteroaromatic ring which optionally has 1 or 2 substituents selected from halogen, OH, CN, C₁-C₆-alkyl, C₁-C₆-alkoxy and phenyl, and R^{a}, R^{b} are each independently hydrogen or methyl or together are an oxygen atom or a methylidene group (═CH₂),
R² is C₁-C₁₀-alkyl or C₃-C₈-cycloalkyl or has one of the definitions given for R¹; or
R¹ together with R² is a radical of the formula A: 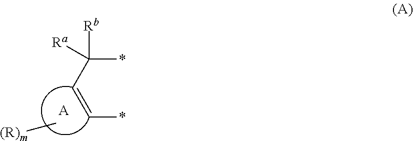
in which A is an aromatic or heteroaromatic ring fused to the double bond, m is 0, 1 or 2, the R radicals may be the same or different and are selected from halogen, CN, C₁-C₆-alkyl, C₁-C₆-hydroxyalkyl, C₁-C₆-alkoxy and phenyl, and R^{a}, R^{b} are each as defined above;
X is O, S or NH;
Y is O, S or NH.

2. A compound according to claim 1, wherein X and Y in formula I are each oxygen.

3. A compound according to either of the preceding claims, wherein R^{a} and R^{b} in the Ar—C(R^{a},R^{b})— unit or in the radical of the formula A are each hydrogen.

4. A compound according to any of the preceding claims, wherein R¹, R² are the same or different and are each an Ar—C(R^{a},R^{b})— radical.

5. A compound according to any of the preceding claims, wherein Ar in the Ar—C(R^{a},R^{b})— unit is an aromatic or heteroaromatic radical selected from phenyl and furyl, where phenyl and furyl are unsubstituted or optionally have 1 or 2 substituents selected from halogen, CN, C₁-C₆-alkyl and C₁-C₆-alkoxy.

6. A compound according to claim 5, wherein Ar in the Ar—C(R^{a},R^{b})— unit is phenyl having 1 or 2 substituents selected from C₁-C₆-alkyl, C₁-C₆-hydroxyalkyl and C₁-C₆-alkoxy.

7. A compound according to claim 6, wherein Ar in the Ar—C(R^{a},R^{b})— unit is 2-methoxyphenyl or 2,4-dimethoxyphenyl.

8. A compound according to any of claims 1 to 3, wherein R¹ and R² together are a radical of the formula A.

9. A compound according to any of claims 1 to 3, wherein R¹ and R² together are a radical of the formula Aa 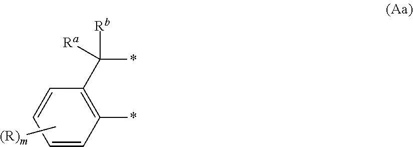
in which m, R, R^{a} and R^{b} are each as defined above.

10. A compound according to claim 9, in which m in formula Aa is 0, 1 or 2, R is selected from hydroxymethyl, methyl and methoxy, R^{a} and R^{b} are each hydrogen.

11. A process for producing a tin oxide-containing polymer composite material composed of
a) at least one inorganic tin oxide phase; and
b) an organic polymer phase;
comprising the polymerization of at least one compound of the formula I according to any of claims 1 to 7 under polymerization conditions under which both the Ar—C(R^{a},R^{b}) radicals polymerize to form the organic polymer phase and the XSnY unit to form the tin oxide phase.

12. The process according to claim 11, wherein the polymerization of the compound of the formula I is performed in an aprotic organic solvent.

13. The process according to either of claims 11 and 12, wherein the polymerization of the compound of the formula I is initiated by adding at least one acid.

14. A tin oxide-containing polymer composite material composed of
a) at least one inorganic tin oxide phase; and
b) an organic polymer phase;
obtainable by a process according to any of claims 11 to 13.

15. The polymer composite material according to claim 14, in which the organic polymer phase and the inorganic tin oxide phase form essentially co-continuous phase domains, the mean distance between two adjacent domains of identical phases being not more than 100 nm.

16. The polymer composite material according to claim 14 or 15, in which the tin oxide phase is present essentially in the form of tin(II) oxide.

17. A process for producing a tin-carbon composite material composed of at least one inorganic tin-containing phase in which the tin is present in the +2 or 0 oxidation state or in the form of a mixture thereof; and
of a carbon phase in which carbon is present in elemental form; comprising
i. the provision of a tin oxide-containing polymer composite material composed of
a) at least one inorganic tin oxide phase; and
b) an organic polymer phase;
by a process according to any of claims 11 to 13; and
ii. carbonization of the organic polymer phase of the polymer composite material obtained in step i.

18. The process according to claim 17, wherein the carbonization is performed at a temperature in the range from 400 to 1800° C. in an essentially oxygen-free atmosphere.

19. The process according to claim 17 or 18, wherein the carbonization is performed at a temperature in the range from 400 to 1800° C. in an atmosphere comprising reducing gases.

20. A tin-carbon composite material composed of
at least one inorganic tin-containing phase Z in which the tin is present in the +2 or 0 oxidation state or in the form of a mixture thereof; and
of a carbon phase C in which carbon is present essentially in elemental form;
obtainable by a process according to any of claims 17 to 19.

21. The tin-carbon composite material according to claim 20, in which the carbon phase C and the tin-containing phase Z form essentially co-continuous phase domains, the mean distance between two adjacent domains of identical phases being not more than 100 nm.

22. The tin-carbon composite material according to claim 20, in which the carbon phase C is continuous and the tin-containing phase Z forms essentially isolated domains, the size of one domain being between 1 nm and 20 μm.

23. The tin-carbon composite material according to claim 20, 21 or 22, in which the tin-containing phase Z consists essentially to an extent of at least 90% of elemental tin.

24. The use of a tin-carbon composite material according to any of claims 20 to 23 for production of electrochemical cells.

25. The use of a tin-carbon composite material according to any of claims 20 to 23 in an anode for lithium ion cells, especially lithium ion secondary cells.

26. An anode for lithium ion cells comprising at least one tin-carbon composite material according to any of claims 20 to 23.

27. A lithium ion cell comprising at least one anode according to claim 26.
